(19) United States
(12) Patent Application Publication
(10) Pub. No.: US 2023/0235584 A1
(43) Pub. Date: Jul. 27, 2023

(54) MODULAR TRAINING SYSTEM

(71) Applicant: Taylord Containers LLC, Spokane Valley, WA (US)

(72) Inventor: Taylor Rowan, Spokane Valley, WA (US)

(21) Appl. No.: 18/102,622

(22) Filed: Jan. 27, 2023

Related U.S. Application Data
(60) Provisional application No. 63/303,937, filed on Jan. 27, 2022.
(60) Provisional application No. 63/355,042, filed on Jun. 23, 2022.

(51) Int. Cl. E04H 1/12

(52) U.S. Cl. CPC E04H 1/1205; A62C 99/0081

(57) ABSTRACT

A system may include a first training module configured to train a first skill. A system may include a second training module configured to train a second skill, the second module selectively coupleable to the first training module in a multiple of limited configurations relative to each other.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In some aspects, the techniques described herein relate to a training system including: a first training module configured to train a first skill; and a second training module configured to train a second skill, the second module selectively coupleable to the first training module in a multiple of limited configurations relative to each other.

In some aspects, the techniques described herein relate to a training system, wherein the first training module and second training module, when coupled together, have a footprint below a first area threshold.

In some aspects, the techniques described herein relate to a training system, wherein the first training module is coupled to the second training module via a first receiver union in a first orientation and the first training module is coupled to the second training module via a second receiver union in a second orientation.

In some aspects, the techniques described herein relate to a training system, wherein the first training module is disposed at a first level and the second training module is disposed at a second level, where the first level and the second level are different.

In some aspects, the techniques described herein relate to a training system, wherein the first training module is configured to selectively receive a movement module.

In some aspects, the techniques described herein relate to a training system, wherein the movement module includes one or more of a set of wheels, a lift jack, a towing anchor, a lift anchor, a securing anchor, or a lift cavity.

In some aspects, the techniques described herein relate to an adjustable surface system including: a first surface mount configured to support a first portion of a surface; a second surface mount spaced from the first surface mount configured to support a second portion of the surface; and a vertical support including: a plurality of selectable anchor locations configured to detachably receive and support the first surface mount, at least one anchor location of the plurality of selectable anchor locations configured, when selected, to restrict movement of the first surface mount in two substantially orthogonal directions of movement.

In some aspects, the techniques described herein relate to an adjustable surface system, the two substantially orthogonal directions including down and away from the second surface mount.

In some aspects, the techniques described herein relate to an adjustable surface system, the at least one anchor location configured, when selected, to restrict movement of the first surface mount in three substantially orthogonal directions of movement.

In some aspects, the techniques described herein relate to an adjustable surface system, the at least one anchor location including a gullet configuration, a J-hook configuration, an L-hook configuration, or a combination thereof (discuss left and right movement in spec. can put features on first surface mount or size a width of the vertical support to engage the first surface mount.

In some aspects, the techniques described herein relate to an adjustable surface system, the adjustable surface system further including another vertical support configured to support the second surface mount.

In some aspects, the techniques described herein relate to an adjustable surface system, further including another vertical support configured to support the second surface mount, the other vertical support movably coupleable to a training system.

In some aspects, the techniques described herein relate to a method of constructing a training system including: removing a first portion of a shipping container, the first portion including: a first upper quadrant of a first side distal to an opening of the shipping container; a second upper quadrant of a second side distal to the opening, opposite the first upper quadrant; and a roof portion, the roof portion including a first edge adjacent to an upper edge of the first upper quadrant, a second edge spaced from the first edge and adjacent to an upper edge of the second quadrant, a third edge having a first end proximate to an upper corner of the first upper quadrant distal to the opening and a second end proximate to an upper corner of the second upper quadrant distal to the opening, and a fourth edge separated from the third edge proximate to a remaining portion of the shipping container roof; separating the first upper quadrant and second upper quadrant from the roof portion; attaching the roof portion to the shipping container to a portion of the first side and the second side remaining on the shipping container after the first portion is removed; attaching portions of the first upper quadrant and the second upper quadrant between the remaining portion of the shipping container roof and the fourth edge of the roof portion; and attaching a training module feature to the shipping container.

In some aspects, the techniques described herein relate to a method, further including: attaching a vertical support for an adjustable surface training module between the remaining portion of the shipping container roof and the roof portion.

In some aspects, the techniques described herein relate to a method, wherein the vertical support includes a gullet configuration, a J-hook configuration, an L-hook configuration, or a combination thereof.

In some aspects, the techniques described herein relate to a method, further including: removing a portion of the first side of the shipping container; and attaching a door training module in place of the removed portion.

In some aspects, the techniques described herein relate to a method, further including: removing a portion of the second side of the shipping container; and attaching a window training module in place of the removed portion.

In some aspects, the techniques described herein relate to a method, further including: attaching a pivotable egress window module adjacent to the remaining portion of the shipping container roof.

In some aspects, the techniques described herein relate to a method, further including: configuring a space below the roof portion as a confined space training module.

In some aspects, the techniques described herein relate to a method, further including: attaching a movement module to a lower portion of the shipping container.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows a perspective view of an illustrative example of the MTS with multiple elements combined.

FIG. 2 shows a perspective view of an illustrative example of the MTS with multiple elements combined.

FIG. 3 shows an illustrative example of a shipping container being coupled to an MTS.

FIG. 4 shows an illustrative example of a shipping container being coupled to an MTS.

FIG. 5 shows an illustrative MTS having a first module and a second module.

FIG. 6 shows an MTS having an elevated egress module.

FIG. 7 shows a perspective view of an illustrative example of the MTS with multiple elements combined.

FIG. 8 shows a perspective view of an illustrative example of an MTS with multiple elements combined.

FIG. 9 shows a perspective view of an MTS.

FIG. 10 shows an end view of an MTS fitted with an adjustable surface system and a confirmed space module.

FIGS. 11A and B show perspective views of illustrative forcible entry door system.

FIG. 11B shows a perspective view of an illustrative forcible entry door jam 1108.

FIGS. 12A and B show illustrative forcible entry door systems.

FIG. 12B shows an illustrative door having replaceable tabs.

FIG. 13 shows perspective views of an illustrative adjustable roofing system.

FIG. 14 is a flowchart of an example method for constructing a training system.

FIG. 15 shows a side view of an illustrative shipping container where a first portion is removed from the illustrative shipping container.

FIG. 16 shows a side view of an illustrative MTS with an elevated egress module on top.

FIG. 17 shows a perspective view of an illustrative MTS with an elevated egress module folded down in a stowed configuration.

### DETAILED DESCRIPTION

### Overview

This disclosure is directed to modular training systems (MTSs). In examples, a compact training device may allow any fire station to have critical training devices onsite. In examples, the system is mobile and can be added on to current training structures (e.g., shipping containers) or be used as a stand-alone device. In some examples, an MTS may comprise one or two piece and may be based on common shipping container sizes. In examples, an MTS may be approximately 8′ wide and between 4′ and 20′ long. In examples, an MTS may have two portions, Side A and Side B. In examples, Side A may be 4′ long×8′ wide×8′ 6″ tall. Side B may be 8′ wide×8′ long×8′6″ tall (e.g., the same width and height as a standard shipping container). Examples also include receiver pockets configured to adapt training devices to other training devices, systems, or the like. Additionally or alternatively, various receiver pockets are configured to allow additional training devices to be installed and trained on.

Most fire stations lack sufficient room for traditional fire training systems and often are required to travel to a common training location with dedicated structures and props. In contrast, examples, of the present disclosure have a small footprint when compared to traditional systems. For example, some implementations of the modular training system may be located within a standard parking spot and may be mobile so that it can be moved around a facility, parking lot, or even into a truck bay. In the present discussion, some examples are directed towards fire fighter training. However, the disclosure is also directed to other sectors including, but not limited to training systems for military, SWAT, EMS, among others.

In examples, an MTS may be configured to have a small footprint so it could easily be placed in a parking lot. In examples, the MTS may include units and/or props. The units and MTS can be customized to have multiple configurations. In examples, the MTS or units can have both sections as shown or be broken down into single units. Each unit has receiving pockets so additional training apparatuses can be added at any time or customized at the facility. This unit is not exclusive to shipping container materials. It can be built out of other materials like steel, aluminum, wood or others to accomplish the design and intended use.

In examples, the MTS and/or units can be modified to have multiple doors or multiple windows. The door and window location can be changed. This prop is not limited to two sections. In examples, additional sections could be added (entanglement, live burn pod etc.). A container can be added between the props or next to them for additional training modules. All sides can be rearranged into multiple configurations. Props can be added on top of containers to practice higher elevation training. The units can split to simulate crossing large gaps.

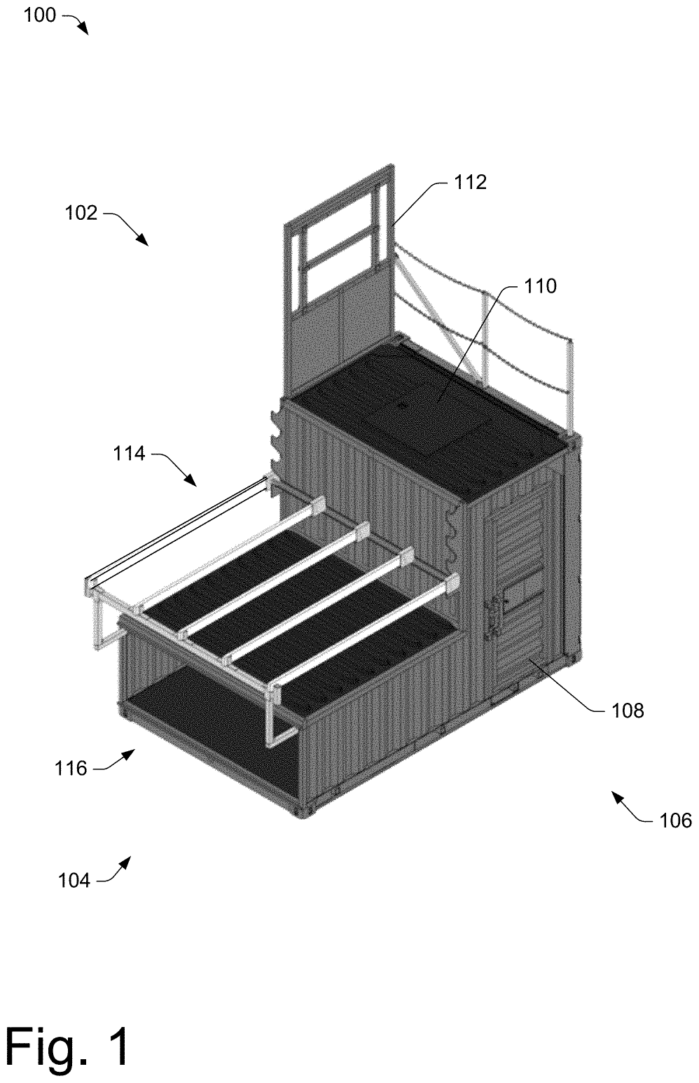

FIG. 1 shows a perspective view of an illustrative example of the MTS 100 with multiple elements combined. For example, FIG. 1 shows an MTS 100 having a module support base 102. In some examples the module support base 102 may be based on a shipping container. In some examples, module support base 102 has a first module substructure 104 and a second module substructure 106. In examples, the first module substructure 104 and/or the second module substructure 106 may support one or more training props. For example, module support base 102 shows the second module substructure 106 supporting a door prop 108, a hatch prop 110, and an egress window module 112. Additionally or alternatively, the second module substructure 106 also supports a portion of an adjustable pitch roof/ramp/floor module 114. Additionally or alternatively, the first module substructure 104 shows support of a portion of the floor module 114 as well as a confined space prop 116. In examples, the hatch prop 110 may be shaped for specific skills. For example, the hatch prop 110 may be circular and replicate a manhole cover.

In examples, the MTS 100 may have a footprint area that is below a threshold. In examples, the threshold is based on a parking spot. In examples, the threshold is 180 square feet or less. In examples, the threshold is 144 square feet or less. In examples, the threshold is 105 square feet or less.

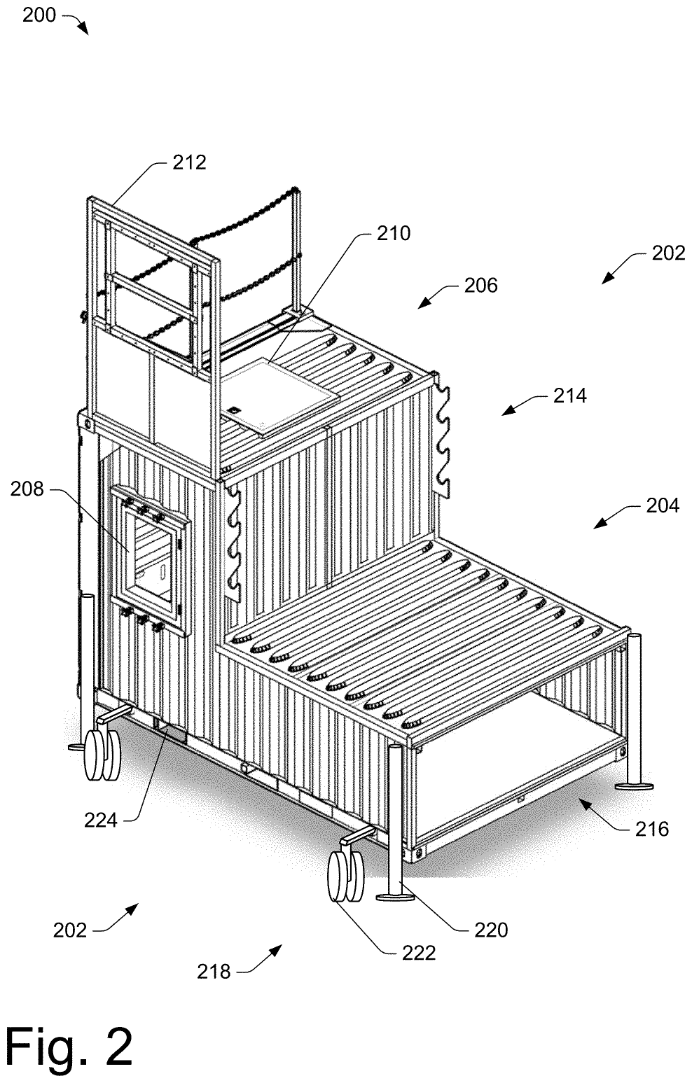

FIG. 2 shows a perspective view of an illustrative example of the MTS with multiple elements combined. FIG. 2 shows an illustrative MTS 200 having a module support base 202. In some examples the module support base 202 may be based on a shipping container. In some examples, module support base 202 has a first module substructure 204 and a second module substructure 206. In examples, the first module substructure 204 and/or the second module substructure 206 may support one or more training props. For example, module support base 202 shows the second module substructure 206 supporting a window prop 208, a hatch prop 210, and an egress window module 212.

Additionally or alternatively, the second module substructure 206 also supports a portion of an adjustable pitch roof/ramp/floor module 214. Additionally or alternatively, the first module substructure 204 shows support of a portion of the floor module 214 as well as a confined space prop 216. Additionally or alternatively, the illustrative MTS 200 shows movement modules 218. For example, a movement module 218 may include a lift jack 220, a wheel system 222, a receiving cavity 224. In examples, the receiving cavity 224 may be configured to releasably and selectively receive lifting mechanisms, anchors, towing equipment, or the like. In examples, the receiving cavity 224 is configured to receive the forks of a forklift. In examples, the receiving cavity 224 is configured to receive the attachment portions of the lift jack 220, the wheel system 222, or combinations thereof among others.

Additionally or alternatively, in examples, a Window Module may include a frame with an opening. In examples, the size of the opening may be similar to common window sizes and may be adjusted or sized to be of certain limited opening sizes to simulate varying degrees of difficulty of entry. In examples, the frame has a spot to hold a consumable sheet good, e.g., OSB or like material (sheetrock, plywood, etc) across the opening that can be penetrated to replicate breaking through the glass of a window in purposes of venting an interior space. In examples, the frame may include a channel or a portion of a channel on opposite sides of the opening. In examples, the sheet good or other materials may be disposed and held within the channel. In examples, the channel may include an angle stock, e.g., angle iron to form a portion of the channel.

Additionally or alternatively, in examples, bar stock (e.g., round and/or square stock with threaded holes is welded onto the top and bottom of the frame to hold disposable bars (e.g., rebar or like material) that may replicate bars on a window. In examples, the bars are held in place by bolts that screw into the threaded holes of the stock as a set screw configuration.

### Illustrative Systems

In some examples, the Modular Training System (MTS) may be coupled to standard shipping containers. In examples, one or more shipping containers may be integrated as to extend or separate individual elements of the MTS. For example, a shipping container may be disposed between two or more elements of the MTS providing an elevated pathway between the two or more elements. In examples, the MTS may also have receiver pockets configured to receive additional elements of the MTS. For example, a staircase system, ram system, railing system, garage door system, among others may be readily integrated, used, removed, and/or swapped out.

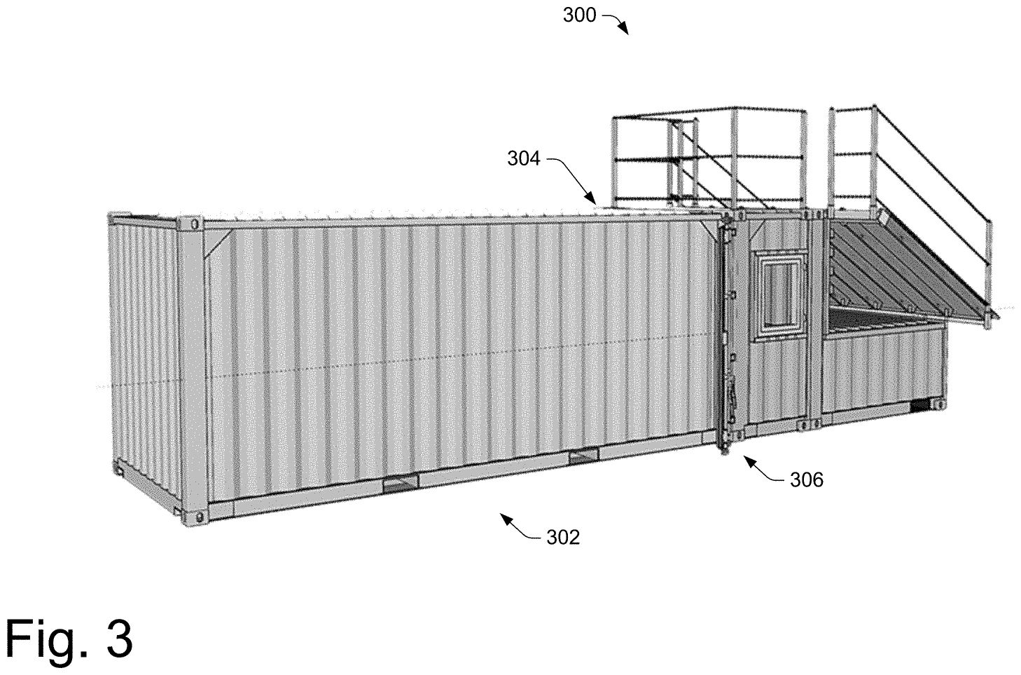

FIG. 3 shows an illustrative example of a shipping container being coupled to an MTS 300. In this example, a shipping container 302 coupled to an end of the MTS 300. In examples, the MTS 300 may include receiver pockets 304 and receiver pockets 306. In examples, complementary receiving pockets may be disposed on the shipping container 302 and may be releasably coupled to receiving pockets 304 and receiver pockets 306, by a fastening system, that may comprise clamps and/or pins among others.

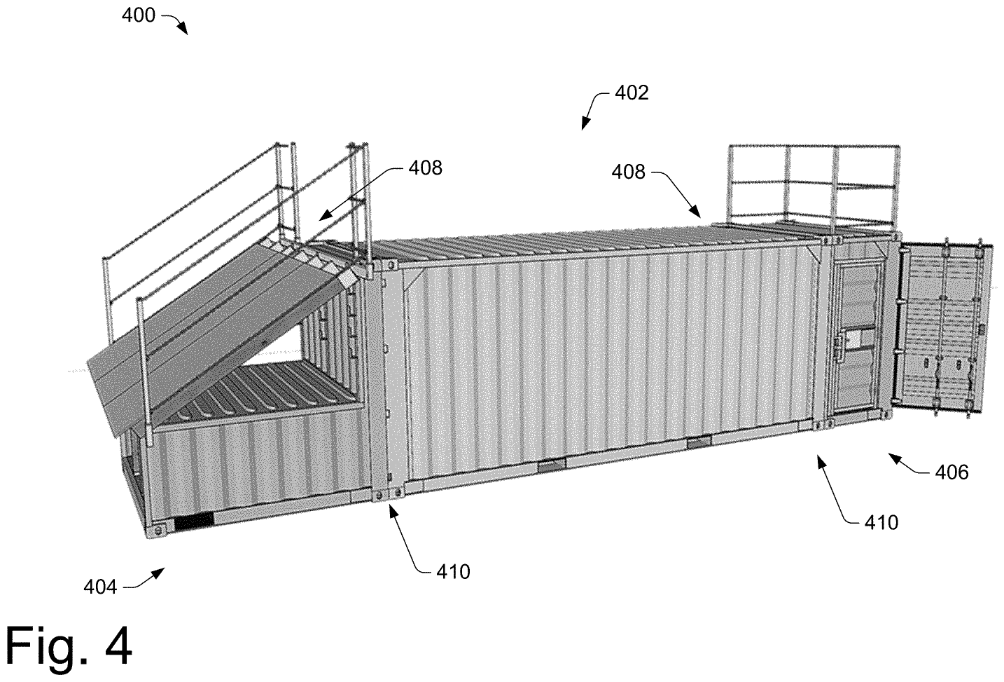

FIG. 4 shows an illustrative example of a shipping container being coupled to an MTS 400. In this example, a shipping container 402 is disposed between, and coupled to, two portions of the MTS 400. In this example, MTS 400 includes a first module 404 and a second module 406. In some examples, the features and capabilities discussed with respect to MTS 100, MTS 200, and MTS 300 are also applicable to the MTS 400. In some examples, the first module 404 and the second module 406 may be coupled directly together. In examples, the MTS 400 may include receiver pockets 408 and receiver pockets 410. In examples, complementary receiving pockets may be disposed on the shipping container 402 and may be releasably coupled to receiving pockets 408 and receiver pockets 410, by a fastening system, that may comprise clamps and/or pins among others.

In examples, the receiving pockets and fastening system may include a locking mechanism that may limit unintended separation. In examples, the receiving pockets and fastening system may include an easy release, a safety release, or a combination thereof. In examples the receiving pockets and fastening system may include an alignment feature that may aid in the alignment of components of the system. In examples, the receiving pockets and fastening system may include a feature to allow larger range of alignments. In examples, the system includes one or more features allowing two of more modules to be selectively aligned and or moved relative to each other.

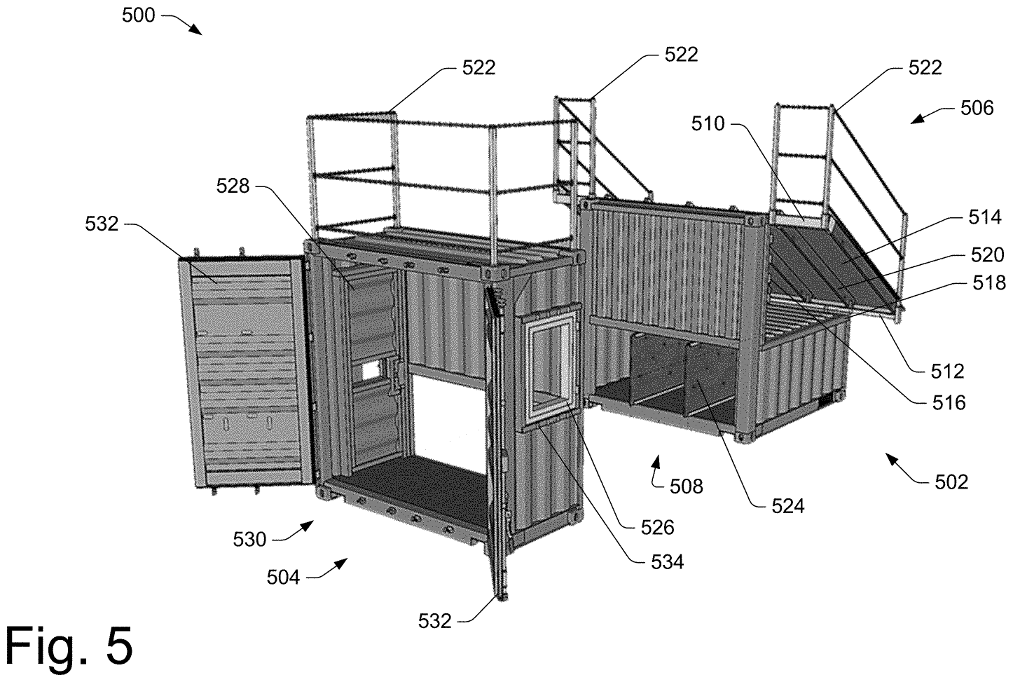

FIG. 5 shows an illustrative MTS 500 having a first module 502 and a second module 504. In this example, the first module 502 and the second module 504 may be separated from each other may stand and be used independently of the other. In this example, the first module 502 includes an adjustable surface system 506 and a confined space module 508. The adjustable surface system 506, in this example, extends beyond the width of the first module 502. In examples, the adjustable surface system 506 includes a first surface mount 510 and a second surface mount 512 configured to support a surface 514. In examples, the height of the first surface mount 510 may be selected by selectively engaging an anchor location on a first vertical support 516. In this example, the second surface mount 512 is supported by a second vertical support 518. In this example, a pitch or angle of the adjustable surface system 506 may be determined based on the relative elevation differences between the selected anchor location on the first vertical support 516 and the second vertical support 518.

Additionally or alternatively, in some examples, the surface 514 is further supported by member 520. In example, member 520 may act as a joist or rafter or similar structural member to support the surface 514. In examples, the member 520 may be made of wood, metal, plastic, composite, or any other suitable material.

Additionally or alternatively, safety features 522 may be attached to the MTS 500, or portions thereof, for example, railings. In examples, the safety features 522 may be removably attached to the MTS 500 depending on the configuration, the props used, the type of training to be conducted, the user's desired level of safety, among other factors and considerations.

Additionally or alternatively, the confined space module 508 may include one more separators 524 to further define the confined space.

In examples, the second module 504 includes a window prop 526, a door prop 528, and a large opening prop 530. In examples, the large opening prop 530 may be opened and/or closed using doors 532. Additionally or alternatively, the large opening prop 530 may be covered by a sheet good or wall simulator to allow a user to practice wall section breaches.

In examples, the window prop 526 may include an opening that may have a replaceable element to simulate breaching a window. In examples, the replaceable element may be a sheet good, for example, a wood, metal, plastic, glass, or composite. Additionally or alternatively, the opening of the window prop 526 may be covered by bars. In examples, replaceable bars may be secured at mounting points 534.

Additionally or alternatively, the door prop 528 may include one or more doors that may open inwards and/or outwards. In examples, the door prop 528 has replaceable consumable components that allow a user to simulate breaching a door.

In examples, the MTS may include multiple levels. In examples, units may be combined with multiple containers. In examples, the units may be elevated above the ground.

### Illustrative Second Story Bailout Window System/Elevated Egress Module

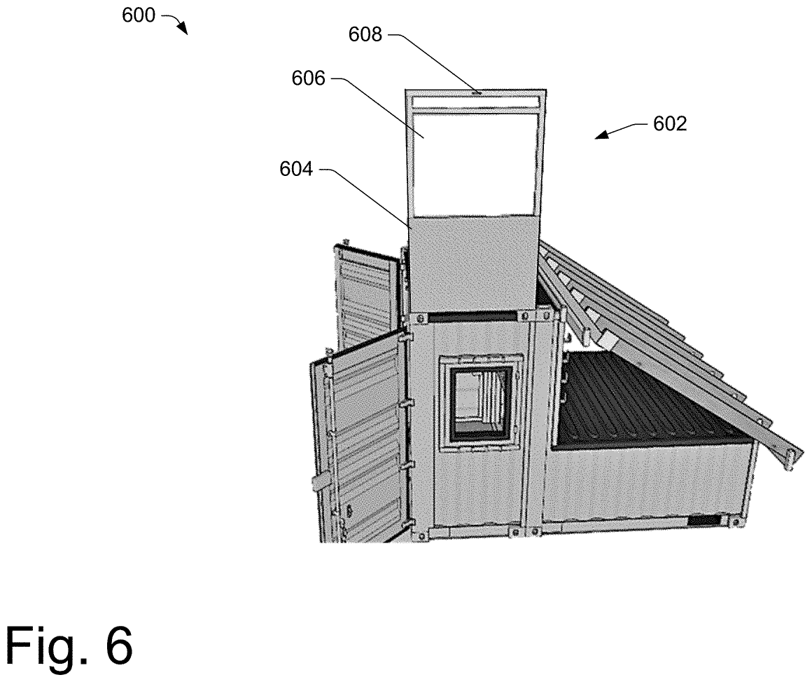

FIG. 6 shows an MTS 600 having an elevated egress module 602. In examples, the elevated egress module 602 may be coupled to an upper surface of the MTS 600. In examples, the elevated egress module 602 may be removable or may fold down during transportation of the MTS 600. Additionally or alternatively, the elevated egress module 602 includes a surface 604 with an opening 606 disposed therein. In examples, the opening 606 may be accessible from the top of the MTS 600. In examples, the elevated egress module 602 includes an anchor point 608. In examples, the anchor point 608 allows for a user to anchor a rope, chain, or other support allowing for a repelling egress or a belay for safety. In examples, a ladder may be extended from the ground or lower surface up to the opening 606 allowing a user to egress on the ladder.

In examples, an MTS may include an upper level, for example, a second story, bail out window on the top of the unit. On the top of the unit there is a safety chain for additional fall protection. In examples, the elevated egress module can be removed or made from other materials such as tube steel or cables etc. The second story bail out window has various tie offs and D rings for fall protection and ventilation. A manhole can be added for tripod rescue training and confined space. There are receiving pockets for the second story bail out window to allow for additional attachments and additional props such as an attic prop, siding, ladders, staircase and can be hung in an upper hinged truss system.

### Illustrative Systems

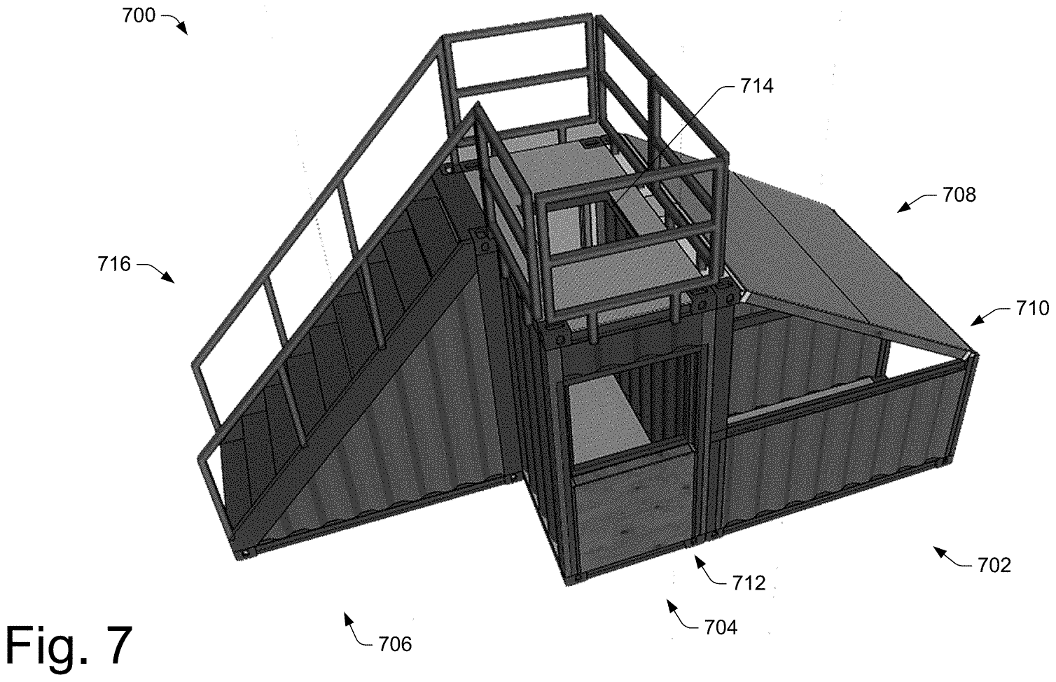

FIG. 7 shows a perspective view of an illustrative example of the MTS 700 with multiple elements combined. For example, FIG. 7 shows an MTS 700 having a first module 702, a second module 704, and third module 706. In examples, the first module 702, the second module 704, and/or the third module 706 may support one or more training props. For example, the first module 702 has an adjustable pitch roof/ramp/floor module 708 as well as a confined space module 710. Additionally or alternatively the second module 704 contains a modular module opening 712 and a hatch prop 714. In examples, the modular module opening 712 is a uniform opening that may be replaceably fitted with an entry door module, a window module, or other training apparatus. In this example, the modular module opening 712 is fitted with a window module.

FIG. 7 also shows the third module 708 coupled to the first module 702 and first module 702. In this example, the third module 708 comprises a stair module 716. In examples, the stair module 716 may be configured to allow easier access to other portions of the MTS 700 or may be configured to allow stair based rescues or egresses.

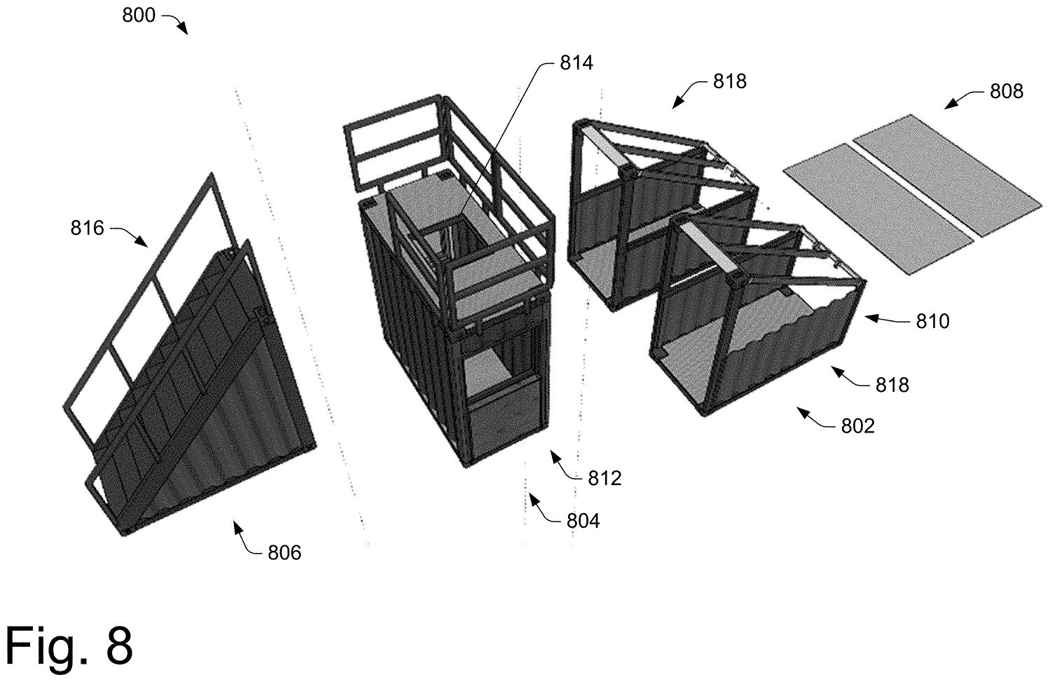

FIG. 8 shows a perspective view of an illustrative example of an MTS 800 with multiple elements combined. In examples, the MTS 800 has some features similar to the MTS 700. For example, FIG. 8 shows a partially disassembled MTS 800 having a first module 802, a second module 804, and third module 806. In examples, the first module 802, the second module 804, and/or the third module 806 may support one or more training props. For example, the first module 802 has an adjustable pitch roof/ramp/floor module 808 as well as a confined space module 810. Additionally or alternatively the second module contains a modular module opening 812 and a hatch prop 814. In examples, the modular module opening 812 is a uniform opening that may be replaceably fitted with an entry door module, a window module, or other training apparatus. In this example, the modular module opening 812 is fitted with a window module.

FIG. 8 also show the third module 806 coupleable to the first module 802 and second module 804. In this example, the third module 806 comprises a stair module 816. In examples, the stair module 816 may be configured to allow easier access to other portions of the MTS 800 or may be configured to allow stair-based rescues or egresses.

Additionally or alternatively, the first module 802 comprises subunits 818. In this example, one or more of the subunits 818 may be used together or independently from each other.

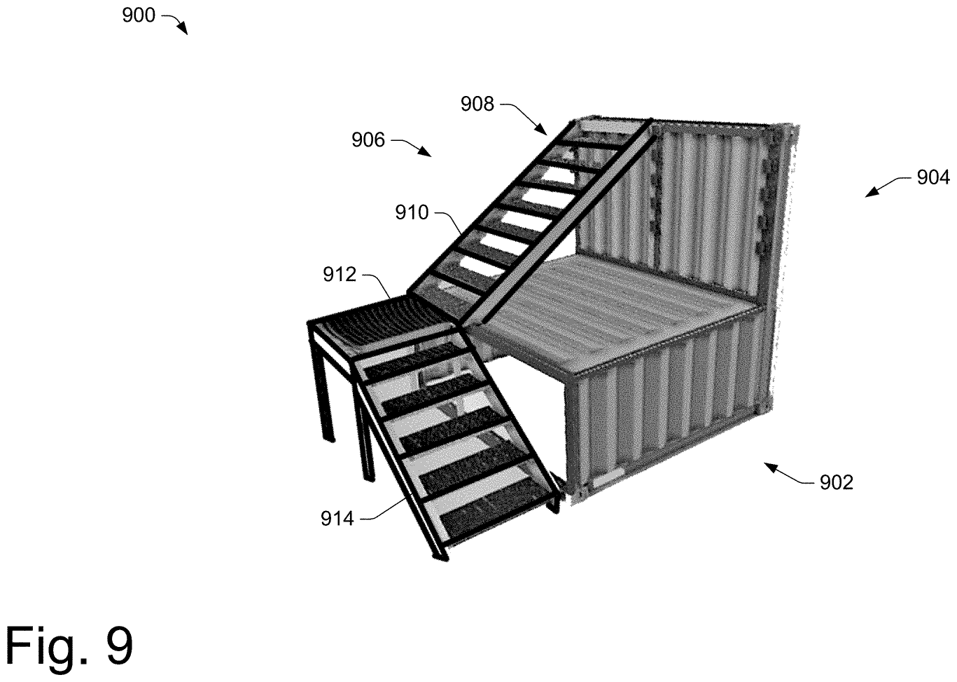

FIG. 9 shows a perspective view of an MTS 900. In this example, the MTS 900 includes a first module 902 having a vertical portion 904. In examples, a stair system 906 is coupled to the first module 902 at an attachment location 908 on the vertical portion 904. Here, the stair system 906 includes an upper stair section 910 coupled to the vertical portion 904 leading and coupled to a landing portion 912, and a lower stair section 914 coupled to the landing portion 912 leading to the ground and or lower surface. In this example, the junction at the landing portion 912 allows for a change in direction of the stairs. In some settings, this allows for a larger set of stairs to be disposed within a smaller footprint.

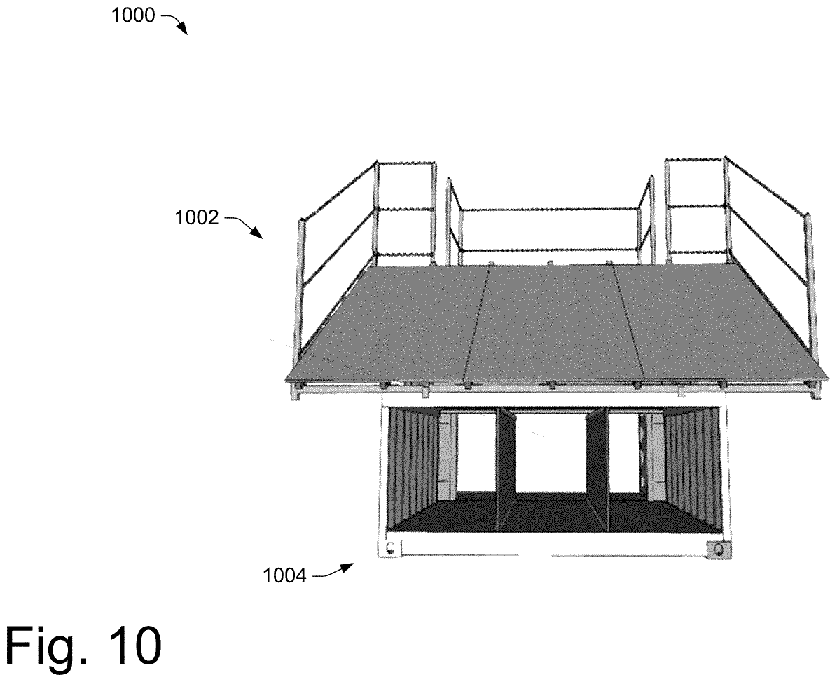

FIG. 10 shows an end view of an MTS 1000 fitted with an adjustable surface system 1002 and a confirmed space module 1004.

### Illustrative Training Modules—Forcible Entry Door

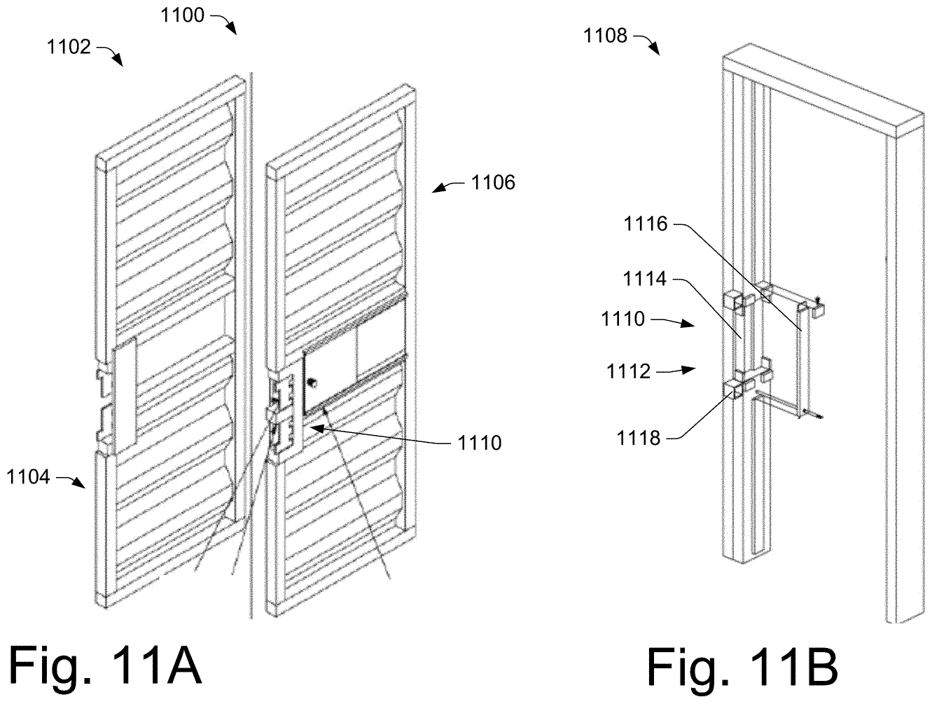

FIGS. 11A and B show perspective views of illustrative forcible entry door system 1100. For example, FIG. 11A shows door system 1102 with an inner door 1104 and an exterior door 1106. In examples, one or more of the inner door 1104 or exterior door 1106 may be engaged in the jam allowing a forceful entry to be performed. In examples, the inner door 1104 and the exterior door 1106 open in different directions.

FIG. 11B shows a perspective view of an illustrative forcible entry door jam 1108. In this example, the illustrative forcible entry door jam 1108 includes a latching system 1110. In examples, the illustrative forcible entry door jam 1108 includes jam portions 1112 of the latching system 1110. In this example, the jam portions 1112 include a consumable/replaceable member 1114 that may be held in place in the jam by retaining feature 1116. In examples, the replaceable member 1114 may be comprised of wood, metal, and or a composite. In examples, where breaching a wooden jam training is desired, the replaceable member 1114 may comprise a piece of wood.

In examples, the MTS includes a forcible entry door module. In examples, the forcible entry door module includes one jam with two facing doors. In examples, the two facing doors open in opposite directions. For example, two doors share one jam, with one inner swinging door and one outer swinging door. Either door can be held open so that the other door can be trained on (latch that holds it open). In examples, the forcible entry door uses a disposable/replaceable/consumable piece of wood that goes in both the jam and door. In examples, the wood is damaged during use of the entry door to simulate breaching a door in the field. In examples, a metal rod located in the door slides through the piece of wood in the jam. Once the door is breached the wood in the jam may be replaced. In examples, a door stop that is secured above and below the jam wood secures it into place, a drop pin secures the lower portion of the stop to allow for easy change out of the jam wood. In examples, a door has two spots that hold wood blocks. The wood in the door acts as a stress reliever on the door. Prying directly to a metal door would put a lot of stress on the hinges and may cause them to break over time incurring higher costs and down time.

In examples, a pocket 1118 may be located in the door jam and door (e.g., 2″×2″ pocket on the jam and door) allowing a block of wood (e.g., 2″×2″) to slide through. In this case the rod in the door is not needed to slide into the jam piece of wood. By doing this the wood in the jam and the door is able to be used for multiple uses. In examples, the only thing replaced now is the 2×2 block.

Additionally or alternatively, illustrative forceful entries door systems include a door that is on barrel hinges to be removed and replaced with different props like explosive entry, disposable door, or wall breaching. The replaceable spring-loaded steel dowel that goes into jamb wood replicates a lock set in the door. Wood inserts can be replaced with metal inserts to simulate a commercial door entry. Wood dowl pockets on the exterior hold disposable wood for breach training. The metal inserts have rubber backing to allow a little give for dowl rod training to imitate forcing a door open. There is one set of doors that swings outward and one that swings inward to better replicate breaching situations. This can simulate limited visibility and confined space breaching. Forcible entry door has a stop that goes across the wood for the halligan to continue for breaching doors.

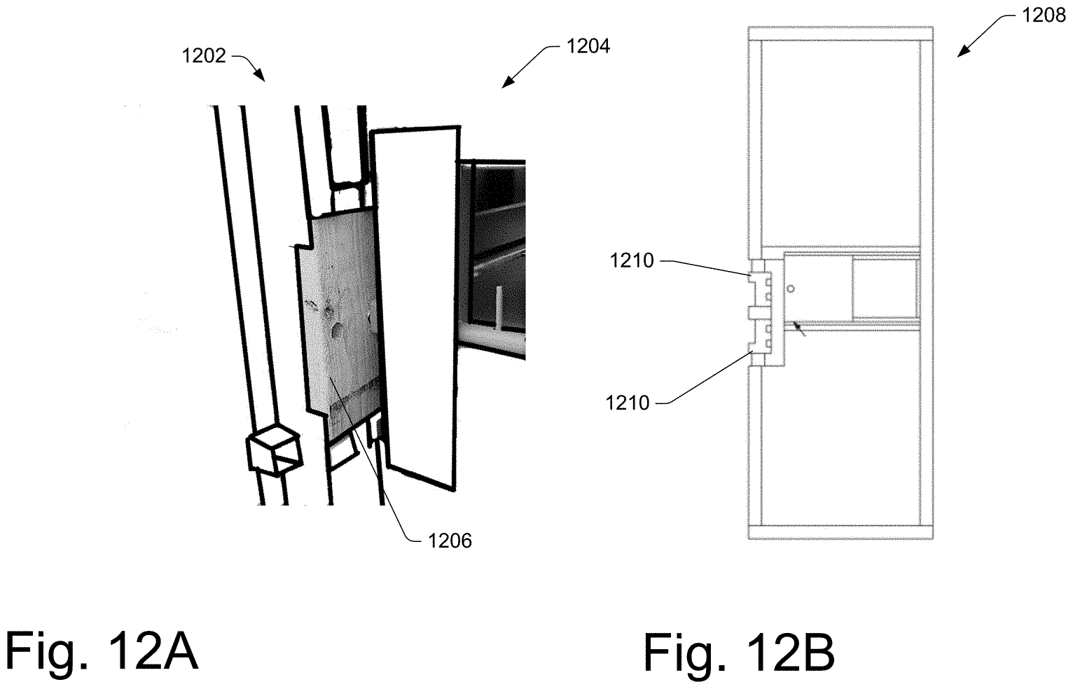

FIGS. 12A and B show illustrative forcible entry door systems. For example, FIG. 12A shows an illustrative door jam 1202 receiving an illustrative door 1204 through a replaceable member 1206. In this example, replaceable member 1206 is made of wood and can simulate breaching a wooden door jam. FIG. 12B shows an illustrative door 1208 having replaceable tabs 1210. In examples, the tabs may be made out of a metal or wood or composite material. In examples, the tabs may be replaceable as they may be damaged or deformed or consumed as part of breaching the door prop.

### Additional Features and Operations

In examples, a window may have an insert on hinges. In examples, the dimensions may be set to desired and/or standard dimensions. For example, a “Denver Prop” window dimensions (20″ wide×28″ tall×42″ off the ground). In examples, the insert is held into place by metal pins.

Additionally or alternatively, the windows may have multiple inserts that can be changed easily. In examples, additional inserts can be added for basement window training and for locksets. For example, an Adams-Rite lock set for commercial store fronts to practice breaking the set screw with the proper technique can be added onto a separate window or door insert. In examples, the inserts will modify the size of the opening for different training applications. The removable bars are placed into pockets in the window frame for quick replacement. The rebar will be able to be mounted vertically or horizontally with the same mounting bracket. The window insert built into the container can be removed and inserted in the elevated egress window.

Additionally or alternatively, additional inserts can be available for each window. One window frame may be for picking lots and have multiple lock sets. These may have specific locks such as padlock, hotel lock, commercial door locks, etc. Window tie offs can be added to simulate high rise rescue. A vent insert may be added. Window sizes can be modified with additional inserts to replicate a basement window.

### Illustrative Roof System

In examples, the MTS may include an adjustable pitch roof module. In examples, the module may include a disposable “truss and roof deck.” In examples, the system may include selectable catches on the frame, a hinged truss system, and a lower truss support.

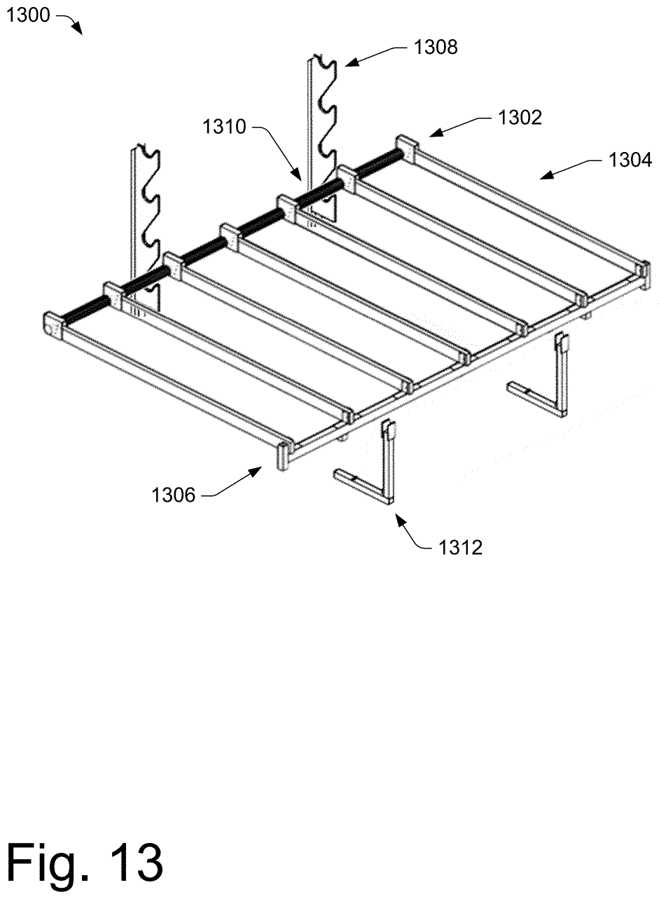

FIG. 13 shows perspective views of an illustrative adjustable roofing system. For example, FIG. 13 shows roofing system 1300. In this example, a first surface mount 1302 is configured to support a surface 1304 (not visible for clarity of other components). FIG. 13 also shows a second surface mount 1306 that is spaced from the first surface mount 1302 and is configured to support a second portion of the surface 1304. FIG. 13 also shows a vertical support 1308 having a plurality of selectable anchor locations 1310 configured to detachably receive and support the first surface mount 1302. In examples, at least one anchor location of the plurality of selectable anchor locations 1310 is configured, when selected, to restrict movement of the first surface mount 1302 in two substantially orthogonal directions of movement. In examples, the two substantially orthogonal directions include down and away from the second surface mount 1306.

In examples, the selectable anchor location 1310 is configured, when selected, to restrict movement of the first surface mount 1302 in three substantially orthogonal directions of movement. In examples, the selectable anchor locations 1310 comprise a gullet configuration, a J-hook configuration, an L-hook configuration, or a combination thereof.

In examples, the roofing system 1300 includes another vertical support 1312 configured to support the second surface mount 1306. Additionally or alternatively, the other vertical support 1312 is movably coupleable to an MTS (not pictured).

In examples, a part of an MTS is in the adjustable roof system. In examples, the roof system is built on a light-weight frame that can manually be moved to adjust the pitch of a roof for different simulations. The square frame sits down into L brackets and has hinges. This design can be modified to have a round attachment bar that sits into saddles to swivel with the pitch adjustment (round rather than square). Additions to this unit can be added to make the roof steeper pitched. The surface of the roof can be made or covered with OSB, shingles, or other materials.

In examples, a roof prop converts to a flat roof surface or platform. It has extension brackets the go into receiving pockets but can have a support post going to the ground. These posts or extension arms can be modified to raise the elevation of the platform for high rise and repel training or second story rescue. A manhole can be added to the roof and container to perform confined space rescues.

In examples, the roof prop has perimeter chain or tube steel for additional fall protection. This can be removed or made from other materials such as tensioned cable. Permanent railing can be added. This prop can come separately if only roof training is required. The receiving pockets will accept a stair system or additional compatible systems. The roof has 8′ and 12′ sections but can be modified to any width. The trusses are 24″ on center but can adjust to 16″ on center or be modified for more specific needs. The trusses are currently 2×6 but is made to accept 2×4 or 2×8. The roof prop can be pinned straight up to simulate a wall using ladders to get over etc.

In examples, “L” brackets may be attached (e.g., welded) to the portions of the MTS that hold the “Upper Hinged Truss System”. In examples, these L bracket locations dictate the pitch of the roof.

### Illustrative Hinged Truss Systems

In examples, the roof system includes a hinged truss system. In examples the hinge allows for rapid reconfiguration between various heights without uninstalling and reinstalling individual trusses.

In examples, the hinged truss system may include 8′ or 12′ Aluminum tube steel sections. Tube steel is connected to truss pockets by hinges. This allows the truss to adjust to the appropriate pitch as it is moved higher or lower on the MTS frame. Truss pockets allow standard sized (e.g., 2×6) pieces of lumber to slide into them. In examples, 2×6 may be held by wood screws, pockets may have screw holes. Truss system has location for railing pockets (fall protection).

In examples, the truss slide may include 8′ or 12′ Long tube steel that has truss saddles welded the top. Truss saddles may have holes drilled into the side so that wood screws can hold the 2×6 wood into place. Wood will sit in saddles at different positions depending on the pitch that the roof is at. Truss Saddles have locations for railing pockets (fall protection).

In examples, the roof portion may be adjusted to be in a flat orientation. In examples, an Extension system may slide into receiver pockets to maximize the cuttable surface area of the flat roof. In examples, the “truss slide” sets on top of the extensions.

In examples, the roof portion may be adjusted to be in a flat orientation. In examples, an Extension system may slide into receiver pockets to maximize the cuttable surface area of the flat roof. In examples, the “truss slide” sets on top of the extensions.

In examples, a Low roof module may be included in the MTS (e.g., Side B). In examples, Side B is used for confined space training. The walls can be adjusted in width and additional walls, wall types and different materials with barriers and breaching apparatuses can be added. A manhole can be added. The inner walls have 2×6 hangers to collapse walls down to 28″. There are tie-offs every foot to add barriers or obstacles like ropes etc. Drywall insert can be added for the confined space inside B to side A to practice cutting through drywall in a small area with low visibility.

In examples, the system may include an adjustable channel to hold plywood (or like material) on the roof and floor. Channel and side walls of containers may have “D Rings” so that ropes, cordage, or other materials (e.g., electrical wires (e.g., housing wire, e.g., Romex) or like material, rope, string, elastic cord (e.g., Bungee cord)) can be installed to replicate confined space training in emergency situations.

### Illustrative Training Module

In examples, the MTS may include an additional training side. In examples, the additional training side receive pockets that can hold recycled garage door panels for cutting simulations or accept other attachments such as a studded framed wall for wall breaching training. This can be modified into a burn training unit. The back end of the prop uses shipping container doors on model. It can have other materials such as a roll up door, wood, etc. Doors or windows can be added to a modified side. In examples, there is an opening between various modules (not required to have this opening). A hatch in the roof of unit A can be added it will use a plywood sheet to replicate an attic scuttle to work in the attic/cockloft from the bottom, and from the top it can be used to anchor tripods and ropes for below/grade, and when combined with the interchangeable plywood tunnels it is a confined space trainer. Different wall inserts (studded wall with plywood, drywall, chain link, etc) can be added. The inner walls have 2×6 hangers to collapse walls down to 28″.

### Illustrative Staircase Training Module(s)

In examples, a staircase attaches to the roof prop and makes a 90 degree turn to practice moving an unconscious person up or down with a ninety degree turn. The bottom part of the stairs can be moved and placed in other areas of the unit, such as under the Denver prop to work from stairs. A second stair case can be added to the bracket to make a 180 degree turn at the top.

### Illustrative Receiver Slots

In examples, the MTS may include multiple receiver sots throughout the modules to hold additional elements and/or modules. In examples, the receiver slots may be standardized to be compatible with other modules and/or elements. The compatibility increases the modularity of the system allowing for a compact footprint and/or simple and secure setup and/or rearrangement of the system.

### Illustrative Mobility Systems

In examples, the MTS may be mobile. In examples, receiver slots may be disposed on the MTS that may hold wheels. In examples, the wheels may be selectively removable.

In examples, receiver slots on the side that allow a jack to insert in and lift one side. Once the side is lifted wheels are inserted, jack lowered and then repeated on the other side. Once the prop is on wheels a “T-Handle” is inserted on the end so that the prop can be pulled.

In examples the process may be common for one or more modules of the MTS.

In examples, portability is a useful feature enabling effective use of the MTS. In examples, the MTS, portions of the MTS, units, and/or props can be loaded onto a flatbed truck with a custom jack system to lift and lower unit. It can be mounted on a trailer with wheels. It has fork pockets on each side for loading or unloading with a forklift. It can be secured in place with corner castings in a permanent location. Wheels can be clipped on and used with custom jack so two pieces can be moved independently. It has 2″×2″ receiver slots that hold wheels. Receiver slots on the side that allow our jack to insert in and lift one side. Once the side is lifted wheels are inserted, jack lowered and then repeated on the other side. Once the prop is on wheels out “T-Handle” is inserted on the end so that the prop can be pulled.

In some examples, the wheels may be rigidly affixed relative to the transverse member. In other examples, the wheels may pivot about a vertical axis. In examples, the wheels may pivot about a vertical axis within a range. In examples, the wheels may be in a stowed configuration where they are inserted in a horizontal configuration.

In examples, the same process may be used for both Side A and B.

### Other Training Attachments

Additional containers can be added with multiple windows or doors for other training applications.

Additionally or alternatively, a Class A or B burn room can be added to the props and used separately or attached to other training modules.

A ceiling breach and pull attachment can be added by utilizing the manhole in side A. This manhole would have a removable hinged door and weight system to achieve the required weight for this test.

In examples, the MTS can be used for CPAT Training (Candidate Physical Ability Test). Forcible Entry Door, Ceiling Breach and Pull can be added. A 60 lb hinged door can be added to side B for using the poke pole with a weighted ceiling device. A hose can be attached to the unit for pulled for training or testing purposes. A tool cabinet can be added in Side B for storage of tools required for the equipment carry evaluation. For ladder raise and extension, two units can be stacked to reach 24′. This will allow them walk to the top rung of the 24′ extension ladder, lift the unhinged end from the ground and walk it up until it is stationary against the wall. A separate attachment can be added for search training. Visibility will be reduced to simulate the critical task of searching for a fire victim in an unpredictable area. This would utilize a 3′ high and 4′ wide tunneled with eyelets for different obstacles to go over and under and two 90 degree turns. The dimensions of the tunnel can be expanded or contracted to adjust width of space at different locations inside the container.

A parapet wall can be added to the top of Side A with the bail out window for training on roof access.

Attachment for wood or steel inserts can be added for mallet training.

A collapsible hatch can be incorporated into another unit to simulate falling through a floor for the mayday drill.

In examples, portions of the MTS maybe narrower than a standard container. Additionally or alternatively, units of the MTS may be combined where two or more units may fit within a width of a container. In examples, the disparate unit types maybe disposed adjacent to each other. For examples, a staircase unit may be disposed next to a roof unit. In examples, where the staircase unit and the roof unit are approximately less than half of a container in width, they may be disposed next to each other and connect to a common container or unit on the same side or edge and remain within a width of a container.

### Illustrative Burn Cell

In examples, the MTS may include and/or receive a burn cell. In examples, the burn cell may be removably disposed in an MTS unit or a container.

In examples, a Conex box may be lined for class A burning. In examples, a unit may comprise a removable cell or box. In examples, the box can be slid into any standard height container to protect the structural components from heat damage while making it easy to replace just the insert and not the entire attachment. This burn room is lined with steel and reinforced and insulated. The floor has fire brick or like material to protect the integrity of the container or structure. Burn room does not have to be inserted into another container and can be stand alone. This does not have to be used with the prop, it can come separate or be integrated into another facility. This room can come do different sizes per customer requirements. Windows, doors, or other apparatuses can be inserted into the burn rooms. This will have receiver pockets for easily moving it around site. Floors will also be reinforced. These can be inserted into any container to allow for class A burn. In examples, the

### Illustrative Processes and Techniques

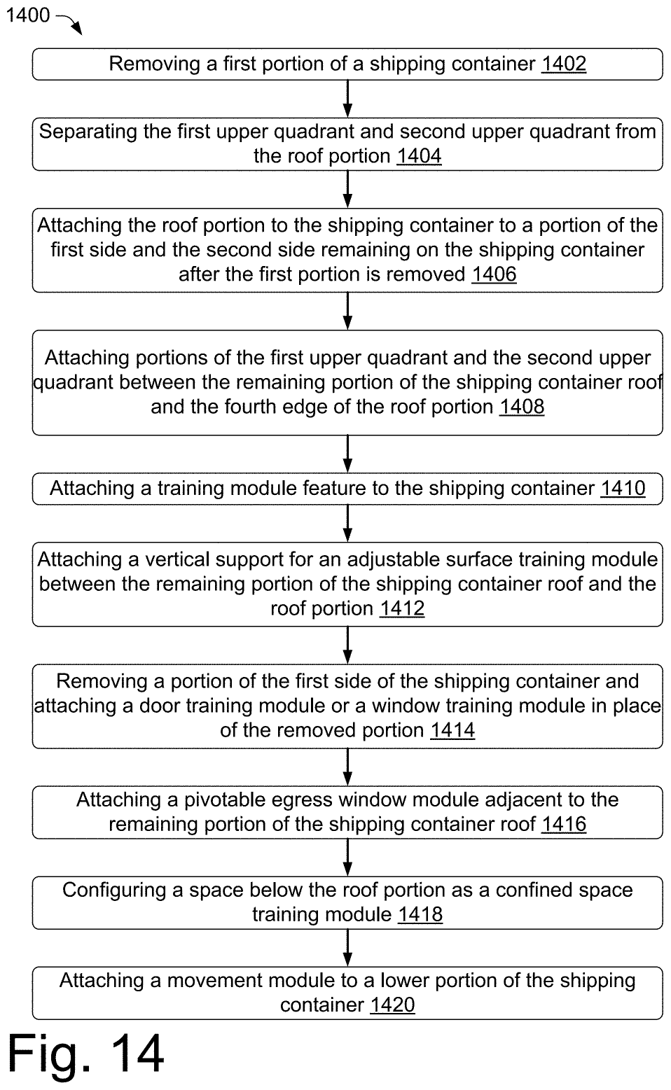

FIG. 14 is a flowchart of an example method 1400 for constructing a training system. In examples, a shipping container is modified to create a training system.

At operation 1402, a first portion of a shipping container is removed. In examples, the first portion comprises a first upper quadrant of a first side distal to an opening of the shipping container, a second upper quadrant of a second side distal to the opening, opposite the first upper quadrant. Additionally or alternatively, a roof portion, the roof portion comprises a first edge adjacent to an upper edge of the first upper quadrant, a second edge spaced from the first edge and adjacent to an upper edge of the second quadrant, a third edge having a first end proximate to an upper corner of the first upper quadrant distal to the opening and a second end proximate to an upper corner of the second upper quadrant distal to the opening, and a fourth edge separated from the third edge proximate to a remaining portion of the shipping container roof.

At operation 1404, the first upper quadrant and second upper quadrant are separated from the roof portion.

At operation 1406, the roof portion to the shipping container is attached to a portion of the first side and the second side remaining on the shipping container after the first portion is removed.

At operation 1408, portions of the first upper quadrant and the second upper quadrant are attached between the remaining portion of the shipping container roof and the fourth edge of the roof portion.

At operation 1410, a training module feature is attached to the shipping container.

At operation 1412, a vertical support for an adjustable surface training module is attached between the remaining portion of the shipping container roof and the roof portion.

At operation 1414, a portion of the first side of the shipping container is removed and a door training module or a window training module is attached in place of the removed portion.

At operation 1416, a pivotable egress window module is attached adjacent to the remaining portion of the shipping container roof.

At operation 1418, a space below the roof portion is configured as a confined space training module.

At operation 1420, a movement module is attached to a lower portion of the shipping container.

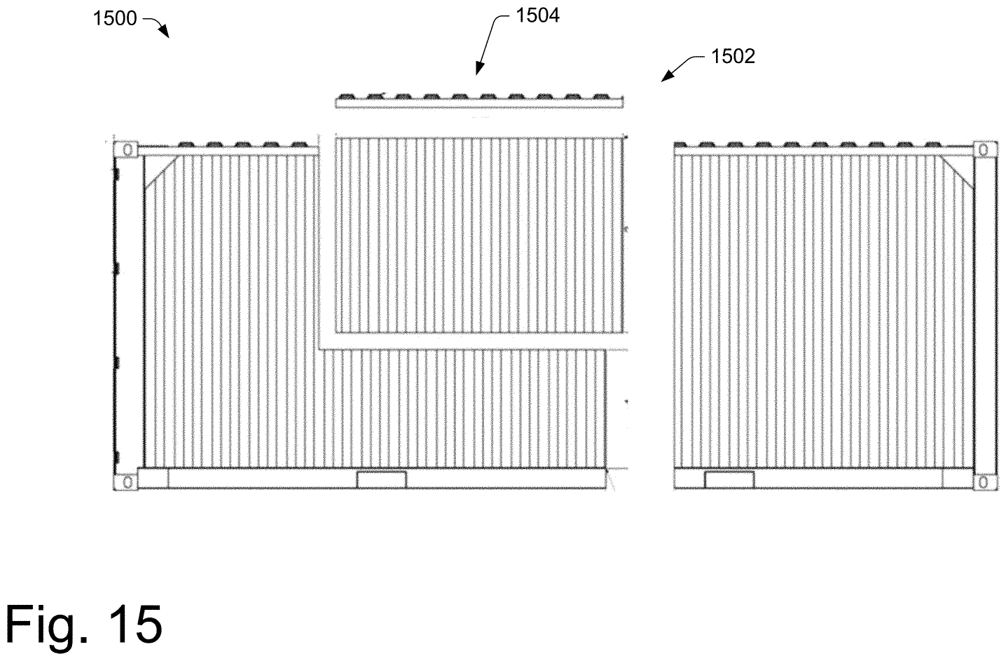

FIG. 15 shows a side view of an illustrative shipping container 1500 where a first portion 1502 is removed from the illustrative shipping container 1500. Additionally, a roof portion 1504 is also removed from the illustrative shipping container 1500.

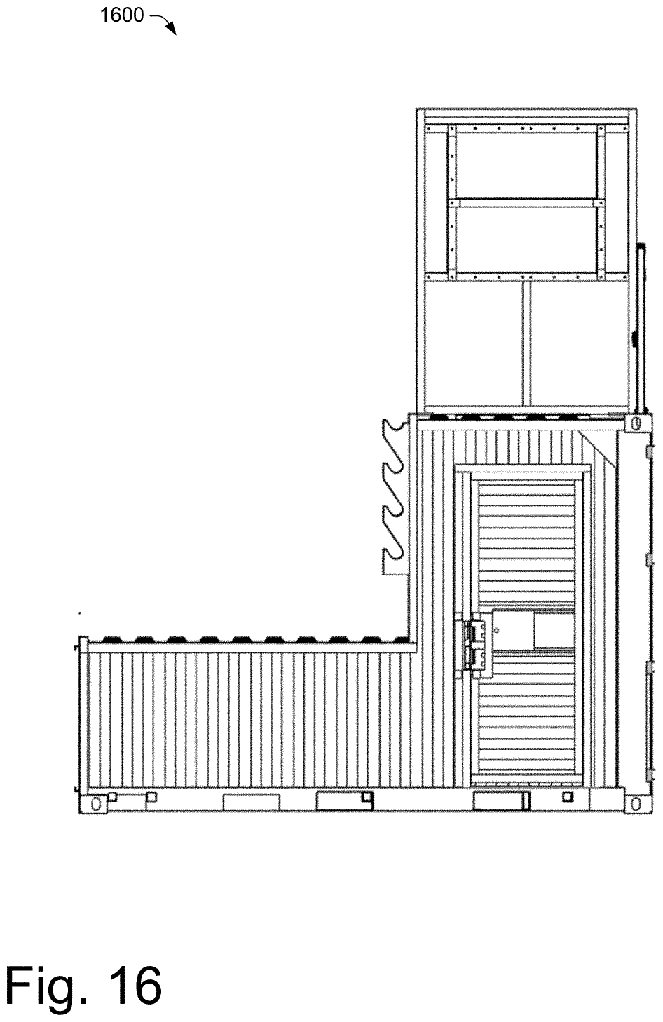

FIG. 16 shows a side view of an illustrative MTS 1600 with an elevated egress module on top.

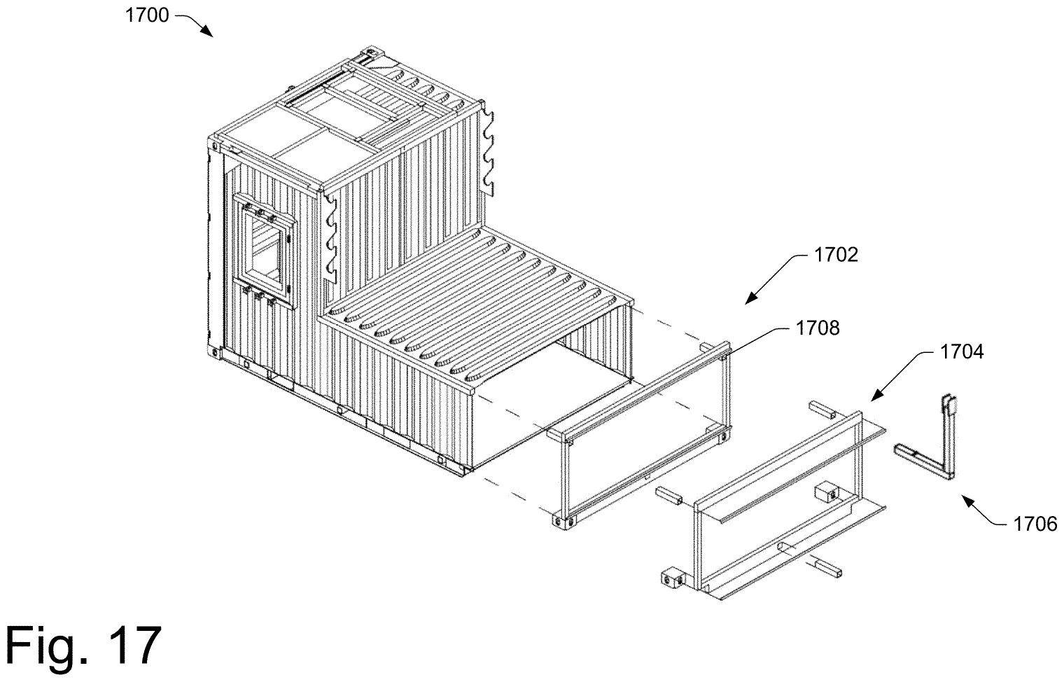

FIG. 17 shows a perspective view of an illustrative MTS 1700 with an elevated egress module folded down in a stowed configuration. In examples, the illustrative MTS 1700 includes a subframe 1702 inserted into an end of the illustrative MTS 1700. FIG. 17 also shows an exploded example subframe 1704 for reference.

Additionally or alternatively, a vertical support 1706 is inserted into a receiving member 1708 of the subframe 1702 to support a roof prop, for example, as the roofing system 1300 discussed with respect to FIG. 13.

### Example Clauses

Any of the example clauses in this section may be used with any other of the example clauses and/or any of the other examples or embodiments described herein.

A: A training system comprising: a first training module configured to train a first skill; and a second training module configured to train a second skill, the second module selectively coupleable to the first training module in a multiple of limited configurations relative to each other.

B: The training system of paragraph A, wherein the first training module and second training module, when coupled together, have a footprint below a first area threshold.

C: The training system of paragraphs A or B, wherein the first training module is coupled to the second training module via a first receiver union in a first orientation and the first training module is coupled to the second training module via a second receiver union in a second orientation.

D: The training system of paragraphs A-C, wherein the first training module is disposed at a first level and the second training module is disposed at a second level, where the first level and the second level are different.

E: The training system of paragraphs A-D, wherein the first training module is configured to selectively receive a movement module.

F: The training system of paragraphs A-E, wherein the movement module comprises one or more of a set of wheels, a lift jack, a towing anchor, a lift anchor, a securing anchor, or a lift cavity.

G: An adjustable surface system comprising: a first surface mount configured to support a first portion of a surface; a second surface mount spaced from the first surface mount and configured to support a second portion of the surface; and a vertical support comprising: a plurality of selectable anchor locations configured to detachably receive and support the first surface mount, at least one anchor location of the plurality of selectable anchor locations configured, when selected, to restrict movement of the first surface mount in two substantially orthogonal directions of movement.

H: The adjustable surface system of paragraph G, the two substantially orthogonal directions comprising down and away from the second surface mount.

I: The adjustable surface system of paragraphs G or H, the at least one anchor location configured, when selected, to restrict movement of the first surface mount in three substantially orthogonal directions of movement.

J: The adjustable surface system of paragraphs G-I, the at least one anchor location comprising a gullet configuration, a J-hook configuration, an L-hook configuration, or a combination thereof.

K: The adjustable surface system of paragraphs G-J, the adjustable surface system further comprising another vertical support configured to support the second surface mount.

L: The adjustable surface system of paragraphs G-K, further comprising another vertical support configured to support the second surface mount, the other vertical support movably coupleable to a training system.

M: A method of constructing a training system comprising: removing a first portion of a shipping container, the first portion comprising: a first upper quadrant of a first side distal to an opening of the shipping container; a second upper quadrant of a second side distal to the opening, opposite the first upper quadrant; and a roof portion, the roof portion comprising a first edge adjacent to an upper edge of the first upper quadrant, a second edge spaced from the first edge and adjacent to an upper edge of the second quadrant, a third edge having a first end proximate to an upper corner of the first upper quadrant distal to the opening and a second end proximate to an upper corner of the second upper quadrant distal to the opening, and a fourth edge separated from the third edge proximate to a remaining portion of the shipping container roof; separating the first upper quadrant and second upper quadrant from the roof portion; attaching the roof portion to the shipping container to a portion of the first side and the second side remaining on the shipping container after the first portion is removed; attaching portions of the first upper quadrant and the second upper quadrant between the remaining portion of the shipping container roof and the fourth edge of the roof portion; and attaching a training module feature to the shipping container.

N: The method of paragraph M, further comprising: attaching a vertical support for an adjustable surface training module between the remaining portion of the shipping container roof and the roof portion.

O: The method of paragraphs M or N, wherein the vertical support comprises a gullet configuration, a J-hook configuration, an L-hook configuration, or a combination thereof.

P: The method of paragraphs M-O, further comprising: removing a portion of the first side of the shipping container; and attaching a door training module in place of the removed portion.

Q: The method of paragraphs M-P, further comprising: removing a portion of the second side of the shipping container; and attaching a window training module in place of the removed portion.

R: The method of paragraphs M-Q, further comprising: attaching a pivotable egress window module adjacent to the remaining portion of the shipping container roof.

S: The method of paragraphs M-R, further comprising: configuring a space below the roof portion as a confined space training module.

T: The method of paragraphs M-S, further comprising: attaching a movement module to a lower portion of the shipping container.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders.

What is claimed is:

1. A training system comprising:
a first training module configured to train a first skill; and
a second training module configured to train a second skill, the second module selectively coupleable to the first training module in a multiple of limited configurations relative to each other.

2. The training system of claim 1, wherein the first training module and second training module, when coupled together, have a footprint below a first area threshold.

3. The training system of claim 1, wherein the first training module is coupled to the second training module via a first receiver union in a first orientation and the first training module is coupled to the second training module via a second receiver union in a second orientation.

4. The training system of claim 1, wherein the first training module is disposed at a first level and the second training module is disposed at a second level, where the first level and the second level are different.

5. The training system of claim 1, wherein the first training module is configured to selectively receive a movement module.

6. The training system of claim 5, wherein the movement module comprises one or more of a set of wheels, a lift jack, a towing anchor, a lift anchor, a securing anchor, or a lift cavity.

7. An adjustable surface system comprising:
a first surface mount configured to support a first portion of a surface;
a second surface mount spaced from the first surface mount and configured to support a second portion of the surface; and
a vertical support comprising:
a plurality of selectable anchor locations configured to detachably receive and support the first surface mount, at least one anchor location of the plurality of selectable anchor locations configured, when selected, to restrict movement of the first surface mount in two substantially orthogonal directions of movement.

8. The adjustable surface system of claim 7, the two substantially orthogonal directions comprising down and away from the second surface mount.

9. The adjustable surface system of claim 7, the at least one anchor location configured, when selected, to restrict movement of the first surface mount in three substantially orthogonal directions of movement.

10. The adjustable surface system of claim 7, the at least one anchor location comprising a gullet configuration, a J-hook configuration, an L-hook configuration, or a combination thereof.

11. The adjustable surface system of claim 7, the adjustable surface system further comprising another vertical support configured to support the second surface mount.

12. The adjustable surface system of claim 7, further comprising another vertical support configured to support the second surface mount, the other vertical support movably coupleable to a training system.

13. A method of constructing a training system comprising:
removing a first portion of a shipping container, the first portion comprising:
a first upper quadrant of a first side distal to an opening of the shipping container;
a second upper quadrant of a second side distal to the opening, opposite the first upper quadrant; and
a roof portion, the roof portion comprising a first edge adjacent to an upper edge of the first upper quadrant, a second edge spaced from the first edge and adjacent to an upper edge of the second quadrant, a third edge having a first end proximate to an upper corner of the first upper quadrant distal to the opening and a second end proximate to an upper corner of the second upper quadrant distal to the opening, and a fourth edge separated from the third edge proximate to a remaining portion of the shipping container roof;
separating the first upper quadrant and second upper quadrant from the roof portion;
attaching the roof portion to the shipping container to a portion of the first side and the second side remaining on the shipping container after the first portion is removed;
attaching portions of the first upper quadrant and the second upper quadrant between the remaining portion of the shipping container roof and the fourth edge of the roof portion; and
attaching a training module feature to the shipping container.

14. The method of claim 13, further comprising:
attaching a vertical support for an adjustable surface training module between the remaining portion of the shipping container roof and the roof portion.

15. The method of claim 14, wherein the vertical support comprises a gullet configuration, a J-hook configuration, an L-hook configuration, or a combination thereof.

16. The method of claim 13, further comprising:
removing a portion of the first side of the shipping container; and
attaching a door training module in place of the removed portion.

17. The method of claim 13, further comprising:
removing a portion of the second side of the shipping container; and
attaching a window training module in place of the removed portion.

18. The method of claim 13, further comprising:
attaching a pivotable egress window module adjacent to the remaining portion of the shipping container roof.

19. The method of claim 13, further comprising:
configuring a space below the roof portion as a confined space training module.

20. The method of claim 13, further comprising:
attaching a movement module to a lower portion of the shipping container.
